(19) United States
(12) Patent Application Publication
(10) Pub. No.: US 2008/0187630 A1
(43) Pub. Date: Aug. 7, 2008

(54) System and method for coating a food product using a flat line coating system and a food product manufactured therefrom

(75) Inventors: Robert J. Vimini, Salisbury, MD (US); David Gorby, Ocean Pines, MD (US); Sonya Whited, Delmar, MD (US); Greg McCann, Crossville, TN (US)

Correspondence Address: VENABLE LLP, P.O. BOX 34385, WASHINGTON, DC, 20043-9998, US

(73) Assignee: Perdue Holdings, Inc., Wilmington, DE (US)

(21) Appl. No.: 12/068,312

(22) Filed: Feb. 5, 2008

Related U.S. Application Data
(60) Provisional application No. 60/899,556, filed on Feb. 5, 2007.

(51) Int. Cl. A23L 1/315; A23L 1/00; A47J 43/00; A23L 1/31

(52) U.S. Cl. 426/96; 426/292; 426/291; 99/494

(57) ABSTRACT

A system and method of coating a food product and the product coated by the method is disclosed. The method includes the steps of transporting a food product on a conveyor; applying a first coating to the top and bottom surfaces of the food product while the food product is on the conveyor; and subsequently applying a second coating while the food product is on the conveyor. The first coating can include a plurality of crumbs having a mean particle size of between about 2 mm and about 4 mm and provide a rough texture on the food product. The second coating can include a flour based flavoring and or seasoning.

### CROSS-REFERENCE TO RELATED APPLICATION

The present application claims priority from U.S. Provisional Patent Application Ser. No. 60/899,556, which was filed on Feb. 5, 2007, and is incorporated herein by reference in its entirety.

### FIELD OF THE INVENTION

The present invention relates to the field of coating food products using a flat line coating system. More specifically, the invention is an improved system and method for coating a food product with a textured coating and a product made therefrom.

### BACKGROUND OF THE INVENTION

Various processes are known that coat food products, such as with bread crumbs or other coatings. It is commercially advantageous to produce a product with the appearance or texture of a homemade product. In one conventional process to achieve this appearance, the food product and coating are placed in a rotary drum, which is then rotated, allowing the coating to adhere to the exterior surface of the food product. Using this methodology, a flour coating can be applied to, for example, a poultry product such as chicken. As a result of the rotation in the drum, the food product is tumbled repeatedly and vigorously. Because of the repeated tumbling, the coating can get into cracks and crevices in the surface of the product. As the coating builds up within the cracks and crevices of the product and on the surface, nodules or balls of the coating can be formed. The result of the formation of these balls or nodules is that the food product has an appearance as if it were prepared in a homemade coating by repeatedly rolling the food product in the coating.

One drawback to this process is that the tumbling of the food product in the rotary drum may exert undue stresses of the food product, and possibly even break apart the food product, thereby reducing the quality of the product. In particular, because of the stresses exerted on the food product in the tumbling process, the process is not suitable for using a formed or a portioned product. Another drawback of the rotary drum or barrel coating process is that processing is labor intensive. Specifically, once the food product is removed from the barrel breader or drum breader, multiple pieces of the food product tend to be deposited in a single group. As further processing is required, for example frying, par frying, baking or packaging, the pieces must be manually separated prior to this further processing. It would be advantageous if further processing could be accomplished without such manual manipulation.

Thus, there exists a need for a system and a method for coating a food product without subjecting the food product to the stresses of a rotating drum. There is also a need for methods of preparing food products to provide a homemade texture or appearance. There also exists a need for coating processes resulting in a textured appearance that do not require manual manipulation after coating.

### BRIEF SUMMARY OF THE INVENTION

Limited methods exist for preparing coated food products with a generally coarse texture in a commercial environment, for example by the use of multiple coatings. In such systems, the art teaches application of a fine coating as an initial step and a second more coarse coating to provide the coarse texture. However, this method does not provide satisfactory results when a very coarse appearance is desired. For example, the final product when coated by this method often has an appearance that is too granular on the surface. However, contrary to the teachings of the art, it has been found that when a coating is applied in an opposite order, i.e., when a coarse coating is applied in a first step, followed by a less coarse or fine coating, a food product with an unexpectedly improved appearance and texture is obtained.

Briefly, the present invention provides a system and method for of coating a food product and a food product prepared by the method. The method of coating a food product includes the steps of transporting the food product on a conveyor, applying a first coating to the top and bottom surfaces of the food product while the food product is on the conveyor; and subsequently applying a second coating while the food product is on the conveyor to produce a finished food product. The first coating is more coarse than the second coating. The first coating can include a plurality of crumbs having a mean particle size of between about 2 mm and about 4 mm to provide a rough texture on the food product. About 68% of the crumbs can have a particle size of about 4.75 mm or above; and/or about 90% of the crumbs can have a particle size of about 2.4 mm or above. The step of applying a first coating can include applying a first batter; and applying the plurality of first crumbs. The second coating can have a second crumb that is a flour based coating. Applying the second coating can include applying a second batter; and applying the second crumb. A step of pre-dusting of the food product can also be performed.

The invention is also a coated food product manufactured by the above method. The coated food product can be made up of a single portioned food product prepared from multiple whole muscle pieces or portions thereof, or a single whole muscle piece. In particular, the coated food product includes a coating comprising separately applied first and second coatings where the second coating is less coarse than the first coating, and the surface of the coated food product has rough texture. The coated food product can be, for example, a poultry product.

The invention is also a system for coating a food product. The system includes a conveyor for transporting the food product, a means for applying a first coating to the exterior of the food product while the food product is on the conveyor; and a means for applying a second coating that is more coarse than the first coating to the food product while the food product is on the conveyor. The means for applying a first coating can have a means for applying a first batter to the exterior of the food product while the food product is on the conveyor; and a means for coating a first crumb to the exterior of the food product while the food product is on the conveyor. The means for applying a second coating can include a means for applying a second batter to the exterior of the food product while the food product is on the conveyor; and a means for applying a second crumb to the exterior of the food product while the food product is on the conveyor.

### BRIEF DESCRIPTION OF THE DRAWINGS

The accompanying drawings, which are incorporated herein and constitute part of the specification, illustrate an exemplary embodiment of the invention, and, together with the general description given above and the detailed description given below, serve to explain certain features of the invention. In the drawings:

FIG. 1 is a schematic drawing of a coating system according to the present invention;

FIG. 2 is a schematic drawing of a coating system according to an exemplary embodiment of the present invention; and

FIG. 3 is a flowchart illustrating steps to coat a food product according to an exemplary embodiment of the present invention.

### DETAILED DESCRIPTION OF THE INVENTION

Certain terminology is used in the following description for convenience only and is not limiting. The terminology includes words specifically mentioned, derivatives thereof and words of similar import. The exemplary embodiment illustrated below is not intended to be exhaustive or to limit the invention to the precise form disclosed. This embodiment is chosen and described to best explain the principle of the invention and its application in practical use and to enable others skilled in the art to best utilize the invention.

The present invention provides a method for producing coated food products, including whole muscle meat products, portioned products prepared from whole muscle pieces of the food product, such as intact muscle or portions thereof, and formed products. The food product may be poultry, such as chicken or turkey, or other meat products, such as beef or pork. Reference to a specific food product in the present disclosure, such as chicken, is not intended to be limiting.

The present invention provides a flat line system for coating food products. Flat line systems alleviate the problems that have occurred in prior systems that use a drum or barrel breader. In particular, because flat line systems remove the tumbling step which has a tendency to break up a food product, a flat line system is amenable to coating a whole-muscle food product, a formed food product, or a portioned food product. In addition, because a flat line process allows for placement of separate pieces of the meat product, there is no need for manual manipulation of the food product after it is removed from the rotary drum of the breader. Instead, each piece of meat product ends up as a discretely placed and individual piece on a conveyor of the flat line system.

Methods using flat line systems in the prior art have not been able to successfully replicate a homemade appearance on a food product. In order to obtain this appearance, tumbling has been required to distribute a flour coating within the folds, creases and cracks in the food product. Tumbling also has the effect of agglomerating portions of the coating so that the coating has an uneven appearance. In flat line systems that apply multiple distinct coatings, common practice among persons skilled in the art is to apply the coating that gives the final food product its overall appearance as a last step. For example, in order to obtain a rough textured appearance, it is common to apply the rougher or more coarse coating as the final coating. This is intended to impart the overall texture to the outermost portion so that it is most evident. It has been surprisingly found that, when a coarse appearance resembling a homemade product is desired, using a more coarse coating as the first step results in a product with improved physical attributes such as appearance, texture and/or mouthfeel.

According to the present invention, a flat line system can be used to obtain a product having a homemade appearance. This is achieved by using a two-step process involving two separate coating steps. As is well known in the art and as used herein, the term “coating” can have several meanings. A “coating” can be a single layer of a substance, for example a batter or crumb, applied to a food product. “Coating” also refers to an overall coating applied to a product. Thus, a “coating” may comprise several layers applied individually. Accordingly, a coating on a food product may comprise a batter coating and a crumb coating. The particular meaning of the term “coating” used in this application will be clear to persons skilled in the art in view of its context within the present disclosure.

Particular coatings used in the present invention can include “batter” and “crumb” coatings. These terms have the definitions generally known in the art. By way of example and not limitation, a “batter” can generally be considered a liquid or liquid based coating, although this simple definition is not intended to differ from the way that the term “batter” would be understood by persons in the art. Examples of liquids that can be used as a batter or as part of a batter include water, milk, egg whites and egg wash. A liquid based batter can have other components. For example, a batter can be a suspension, emulsion, or solution of the liquid that contains a second liquid or a solid. Examples of other components of a batter include gums, starches and flour.

The term “crumb” is also intended to have its generally accepted meaning in the art. By way of example and not limitation, a “crumb” is generally considered to be a dry component, although this simple definition is not intended to differ from the way that the term “crumb” would be understood by persons in the art. A “crumb” can include, for example, cracker meal, bread crumbs, extruded crumbs, and flour. Bread crumbs can be, for example, varieties commonly known as American crumb or Japanese crumb. Crumbs are available in a range of textures from very fine to very coarse and can include additional ingredients such as flavorings and seasonings.

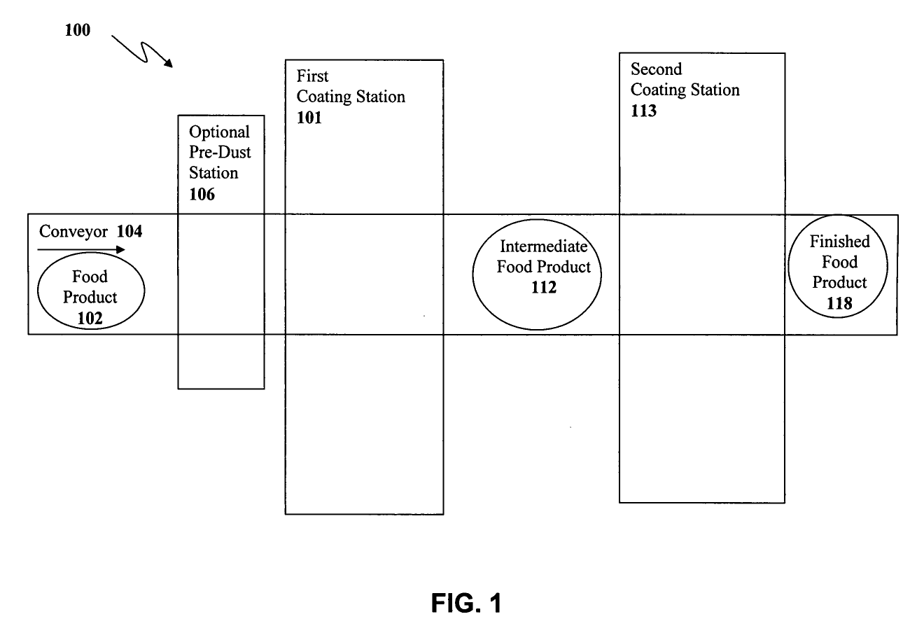

In general, the present invention is a two step process in which two coatings having a different nature are used, specifically where the first coating is more coarse than the second coating or its components, or the first coating includes a component that is more coarse than the second coating or its components. As shown in FIG. 1, embodiments of the present invention include a system 100 that includes a first coating station 101 and second coating station 113 for coating a food product 102. The food product 102 is placed on a conveyor 104 for processing. Optionally, the food product 102 is coated with a pre-dust coating in optional pre-dust station 106. The food product is then coated with the first coating in first coating station 101, to provide an intermediate food product 112. The intermediate food product 112 is then coated with a second coating in second coating station 113 to provide a finished food product 118.

In exemplary embodiments, the first coating includes a first crumb and the second coating includes a second crumb wherein the first crumb is coarser than the second crumb. The terms first and second are used herein to indicate the relative order of the two coatings, although additional coatings may be applied before, after, or intermediate to application of the first and second coatings. For example, a pre-dusting step, such as is known in the art, may be an initial step in which a coating is applied before the first coating. Alternatively, the first coating may be applied instead of or serve as the pre-dust coating. Similarly, additional coatings, for example a barrier coating, can be applied after the first coating and before the second coating or after the second coating. In some embodiments, the barrier coating can be the second coating. The first coating may be comprised of more than one individual coating. For example, the first coating can include a batter and a crumb that can be applied in two separate steps or that can be mixed and applied together. Similarly, the second coating may be comprised of two coatings, for example a batter and a crumb, that can be applied in two separate steps or that can be mixed and applied together.

In exemplary embodiments of the invention, the first coating comprises a first batter and a first crumb, wherein the first batter and first crumb are applied in separate steps, as described in more detail below. Similarly, the second coating in certain embodiments of the invention can comprise a second batter and a second crumb, wherein the second batter and second crumb are applied in separate steps. When two batter steps are utilized, the batter in each step may be the same; however, as described further below, if a pre-dusting step is omitted, the first batter may be different to promote adhesion to a moist or wet food product. According to embodiments of the invention using first and second crumbs, the two crumbs are of a different nature. In particular, the first coating can include first crumbs of, for example, a relatively large size that can be variable in size and impart a primary textural appearance to the finished coated food product. The second coating can comprise a second finer crumb that provides a secondary textural appearance to the coated food product. “Textural appearance” is used herein to refer to a look or appearance that can be associated with a particular texture. An item with a particular textural appearance may or may not have the actual texture associated with the appearance. By using the combinations of coatings with different characteristics such that the first coating imparts a more coarse appearance, a homemade appearance can be imparted on the coated food product. As will be understood by persons skilled in the art, the coating system and method described herein can be varied to provide different appearances in the coated food product. Thus, the exemplary embodiment described herein should not be taken to limit the scope of the invention as it would be understood by persons skilled in the art.

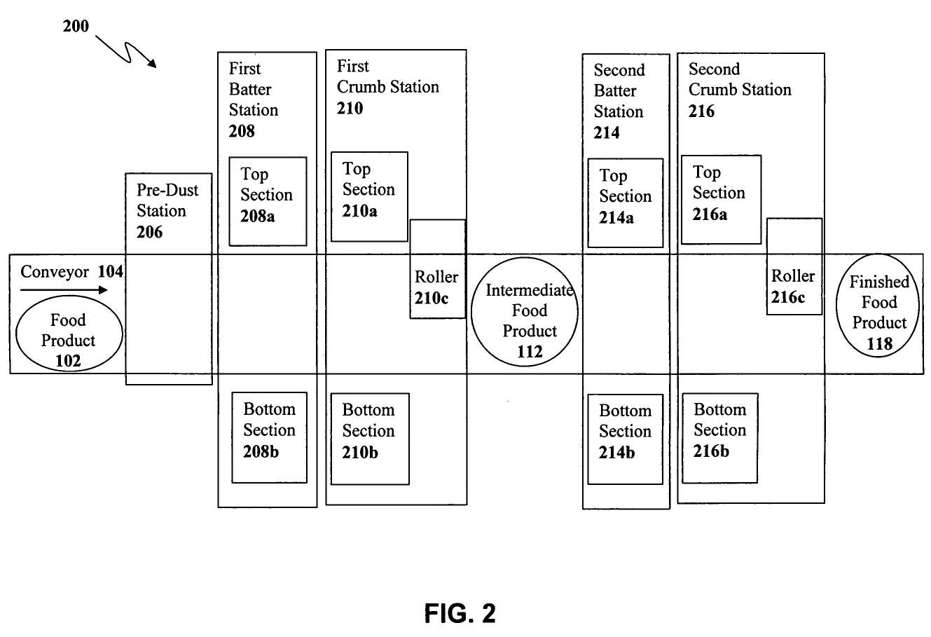

FIG. 2 is a schematic representation of a two pass batter/crumb system 200 (collectively referred to herein as a coating system) for coating a food product 102 according to an exemplary embodiment of the present invention. Food product 102, in a form ready for coating, is placed on conveyor 104. Conveyor 104 may be an endless conveyor or a series of consecutive endless conveyors, as is well known in the art. Optionally, the food product 102 may go through a pre-dust station 206 that applies a pre-dust composition, for example a flour base, to food product 102. The pre-dust composition helps the subsequently applied batter and crumb to adhere to food product 102 during the coating process. Specifically, as is known in the art, the pre-dust produces a drier surface to the food product 102 to promote adhesion of the batter. The pre-dust station, if present, can also be incorporated as part of the batter/crumb system 200 or can be a separate system.

The flat line coating system 200 includes a first batter station 208 that applies a first batter to food product 102. First batter station 208 can include a top section 208a that provides a first batter in a waterfall to top of food product 102 and a bottom (or bed) section 208b that provides a bed of the first batter to coat bottom of food product 102. Alternatively, the first batter can be applied by an immersion process. In the absence of pre-dusting, modification of the first batter may be desirable in order to promote adherence to the food product 102. Modification of the first batter can include, for example, increasing the starch content. Avoidance of the pre-dusting step can be useful in conjunction with the present invention in that it reduces processing time and the space required for processing and preparation.

A first crumb station 210 is disposed downstream of first batter station 208. First crumb station 210 provides a first crumb, for example a dio cut crumb (i.e. an extruded crumb), to food product 102 that adheres to the batter from first batter station 208. First crumb station 210 can include a top section 210a that provides the first crumb in a waterfall to top of food product 102 and a bottom (or bed) section 210b that provides a bed of the first crumb to coat bottom of food product 102. Such a crumb station ensures that the first crumbs completely cover the exterior surface of food product 102 to provide an intermediate food product 112. Other configurations suitable to apply a first crumb to the complete exterior surface of the food product can be used. After food product 102 is coated with the first coating, an adjustable pressure roller 210c can lightly roll over the intermediate food product 112, lightly pressing first coating into the intermediate food product 112 to further ensure adhesion.

A second batter station 214 is disposed downstream of first crumb station 210. Second batter station 214 applies a second coat of a second batter over the intermediate food product 112. Similar to first batter station 208, second batter station 214 can include a top section 214a that provides the second batter in a waterfall to top of intermediate food product 112 and a bottom (or bed) section 214b that provides a bed of the second batter to coat bottom of intermediate food product 112. The second batter can alternatively be applied in an immersion process. The second batter can be a conventional batter that need not be modified to promote adhesion, and can thus be the same as or different from the first batter.

A second crumb station 216 is disposed downstream of second batter station 214. Second crumb station 216 provides a second crumb that is less coarse than the first crumb and adheres to the second batter from second batter station 214. The second crumb can be, for example, a flour based crumb that can include seasoning. A flour/seasoning crumb delivers flavor, coloring, and secondary texture to intermediate food product 112. Similar to first crumb station 210, second crumb station 216 can include a top section 216a that provides the second coating in a waterfall to top of intermediate meat product 112 and a bottom (or bed) section 216b that provides a bed of the second coating to coat bottom of intermediate meat product 112, although other configurations suitable to apply the second crumb to the complete exterior surface of the food product can be used. After the second coating, i.e. the second batter and second crumb, is applied, an adjustable pressure roller 216c can lightly roll over the food product, lightly pressing the second coating into the finished food product 118, to ensure adhesion of the first and second coatings. This process of “flat-line” coating the food product on conveyor 104 can provide an appearance on the finished food product 118 that imitates the appearance achieved by rotating in a drum without the stress of subjecting the food product to being rotated in a drum.

A first coating can be selected to impart a primary textural appearance or feel to the coated food product. For example, the coating can be provided to impart a “homestyle” appearance to the final product. To achieve such an appearance, the first coating can be a crumb comprising a plurality of crumbs having variable sizes. Any suitable crumb station that ensures that the first crumbs completely cover the exterior surface of food product 102 can be utilized. The first crumb can be relatively coarse and have a relatively large particle size or diameter. Measurement of crumb particle size or diameter, including mean particle size and mean diameter, can be made using methods known in the art, for example, methods based on testing with ASTM testing sieves and following ASTM Standards (ASTM International Standards Worldwide). The first crumb can be selected so that about 90 percent of the crumbs have a particle size above about 2 millimeters, and about 70 percent of the crumbs have a particle size above about 4 millimeters. Crumbs have a mean particle size between about 2 millimeters and about 4 millimeters. Use of a crumbs coating comprised of crumbs varying in size provides a good appearance. In exemplary embodiments, crumbs can consist of a mixture wherein about 68% (±about 5%) of the crumbs have a particle size that is retained on a ON#4 sieve or screen (about 4.75 mm); about 22% (±about 5%) of the crumbs have a particle size that is retained on a ON#8 sieve (about 2.4 mm); about 4% (±about 4%) of the crumbs have a particle size that is retained on a ON#20 sieve (about 0.85 mm); about 3% (±about 3%) of the crumbs have a particle size that is retained on a ON#60 sieve (about 0.25 mm); and about 3% (±about 3%) of the crumbs have a fine particle size. Crumbs can be made by an extrusion or granulation process or by other processes known in the art. Producers such as, for example, Southeastern Mills of Rome, Ga., can provide a suitable crumb mixture. Extruded crumbs tend to be more hearty, maintain their appearance and texture throughout the coating process and subsequent operations, and maintain a better texture after cooking without becoming hard or brittle. Such crumbs provide intermediate food product 112 with a rough exterior texture, with cracks and craters throughout, yielding a gnarly surface. When coated with a finer second crumb as described below, this gnarly surface provides the finished food product 118 with a “homestyle” or homemade appearance. The appearance mimics the nodular appearance of homemade products prepared using a drum or barrel breader. Other appearances and textures can be imparted by using crumbs or coatings with different characteristics of size and texture.

In an exemplary embodiment of the invention using large and variably sized crumbs, intermediate food product 112 has a gnarly appearance with relatively large pieces of crumb on the surface. Without further modification, this appearance may excessively jagged and not be commercially acceptable. However, prior art system applying coarse crumbs in a final step would typically yield this jagged and unacceptable appearance. In order to provide a more appealing textural appearance and provide an appearance even more like a homemade or homestyle product, the second batter and second crumb act to impart a more attenuated appearance. That is, by using a finer coating, such as a flour based crumb in the second coating, the abrupt size changes that result from the use of relatively coarse crumbs are transitioned more smoothly across the surface of the finished food product 118. This transitioning of the large particles into a more smooth surface in the finished food product further promotes an appearance which closely resembles that of a homemade hand-rolled, coated food product with nodular depositions of flour and coating on the surface of the food product usually imparted by a hand-rolling type of process.

Although production of “homestyle” products are known, the application of crumbs used to produce such a product using prior art techniques can be problematic. For example, as described above, use of rotating drum systems to apply coating to a product can cause stresses that result in the product breaking into constituent pieces, particularly when the portioned product consists of more than one piece of whole muscle product such as in a formed or portioned product. Furthermore, typical flat line processes used for coating can result in poor adhesion of the coarse crumbs used in homestyle coatings. Also, when coarser crumbs are used in the second coating, the overall appearance of the product is less appealing and can look less like a homemade product. The process of the present invention, for example when used with crumbs having the characteristics described herein, provides good adhesion of the crumbs. Additionally, the process of the present invention results in physical attributes of the final product such as appearance, texture, mouthfeel and flavor, that have previously been difficult to obtain with existing flat line processes. Also, because individual pieces of the meat product remain separated throughout the coating process, manual manipulation of the product after coating is not required, and labor can be reduced.

First and second coatings other than those of the embodiment exemplified in FIG. 2 can be used in the invention. For example, the first coating can be a predominantly dry mixture that includes relatively coarse crumbs that is applied as a modified pre-dusting step. Described in a different way, in this embodiment the pre-dust step is the first coating step. Alternatively, rather than having separate batter and crumb steps, the batter and crumb can be mixed and applied in a single step. Similarly, the second coating can be a dry coating with a finer texture than the first coating. In other embodiments, the second coating can be a mixture of batter and crumbs applied in a single step. As another alternative, the second coating can be a barrier coating. The nature of the first and second coatings and the manner of applying each will depend on, for example, the particular textures desired, the properties of the various batter(s) and/or crumb(s) applied, and the nature of the food product. Different permutations and combinations of coatings and methods of applying them can be used. In view of the teachings of the present invention, persons skilled in the art will be able to vary the particular processes and coatings using routine experiments known in the art by varying the types of coating and methods of application to arrive at a suitably coated food product. The invention requires a two (or more) step coating process that applies a first coating that has a coarser texture than a second coating.

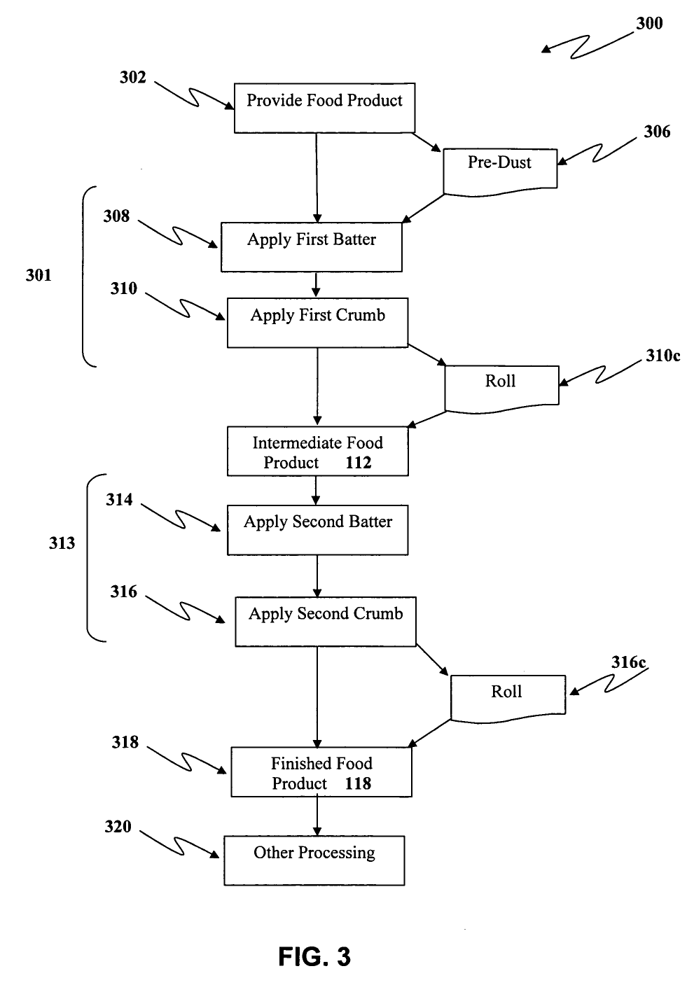

A flow chart 300, illustrating an exemplary process according to an embodiment of the invention for coating a food product 102 is shown in FIG. 3, which should be viewed in conjunction with FIG. 2.

In step 302, a food product 102 is positioned on a conveyor 104. After step 302, an optional pre-dust step 306, may be performed at pre-dust station 206. Pre-dust step 306 prepares food product 102 to accept the batter and first crumb.

In step 301, a first coating is applied to the food product to provided an intermediate food product 112. As described below with respect to exemplary embodiments, step 301 of applying the first coating can include more than one individual step. In step 313, a second coating is applied to the intermediate food product 112 to provided a finished food product 118. As described below with respect to exemplary embodiments, step 313 of applying the second coating can include more than one individual step. In step 320 after application of the second coating, the finished food product 118 can be subjected to further processing.

In an exemplary embodiment of the invention, step 301 of applying a first coating includes several steps. In step 308, a first batter is applied to food product 202 at first batter station 208. As described above, the first batter may have properties that promote adhesion to the food product 102, particularly if pre-dusting step 306 is omitted. In step 310, a first crumb, is applied to food product 102 at first crumb station 210. In optional step 310c, roller 210c rolls crumbs into the intermediate food product 112. The first coating is applied to provide a primary textural appearance. For example, crumbs can be applied in a manner intended to provide a random or consistently inconsistent texture among different intermediate food product 112 such that no two pieces of intermediate food product 112 intentionally appear identical. Steps 308 to 310 or 306 to 310c together form a step 301 of applying a first coating to food product 102, and provide a primary textural appearance to finished food product 118.

In step 314, a coat of a second batter is then applied to intermediate food product 112 at second batter station 214. In step 316, a second crumb, for example, a seasoning coating of flour, that can include spice and/or other flavoring is applied to food product 112 at second crumb station 216. In optional step 316c, roller 216c rolls the second coating into the food product. Steps 314 to 316 or 316c collectively form step 313 of applying a second coating to the food product. The step of applying the second coating provides a secondary textural characteristics to the finished food product 118. In step 318, a finished food product 118 is produced.

In an exemplary embodiment of the invention, step 313 of applying a second coating includes several steps. In step 320, the finished food product 118 leaves batter/crumb station 216 for further processing. Further processing can include cooking, for example frying or par-frying, freezing, and packaging. Finished food product 118 can be fried merely to cook the outer layer of the coated product and thereby set the breading (i.e., “par-fried”), frozen for shipment to customers and packaged. The food product can be heated for a predetermined period of time by customers for consumption.

In some embodiments of the invention, the food product is a meat product. In exemplary embodiments, the meat product is a poultry product such as chicken tenders or portioned chicken tenders. The invention can use jumbo whole tenders to shape a product into the shape of portioned tenders that are then coated to produce a coated food product according to the invention. In larger poultry, whole tenders can typically weigh at least about 47 grams (about 1.6 oz), and can have a weight ranging from about 47 grams to about 242 grams (about 8.5 oz). While whole tenders weighing at least about 47 grams are described, those skilled in the art will recognize that whole tenders of other weights may be used. Whole tenders are generally flat strips of meat located under the breast. Particular whole tenders useful in practicing the invention are skinless, with tendons clipped. Portioned products such as those made from tenders are particularly useful because a product with consistent size and weight can be produced. Prior art coating systems have limited use in coating portioned products due to the stresses incurred in the tumbling process.

Portioned tenders can be prepared by inserting tenders into a tumbler and marinating with a suitable solution. Tenders are tumbled for a time sufficient to fully coat all exposed surfaces with marinating solution. During marination, a vacuum can be applied to open the muscle in tenders, allowing the marinating solution to penetrate the muscle. In preparing portioned tenders, a cooling fluid, such as carbon dioxide, can be pumped into tumbler chill the tenders after marinating to help the tenders to stick together during portioning. This makes the portioned tenders comprising more than one whole tender or multiple portions of tenders less likely to pull apart after portioning and appear in the final food product as a single whole muscle piece. The cooling also facilitates retention of the shape of tenders through the coating process, until the shape is set, such as by frying.

Tenders can be inserted into a feed pump assembly, for example a piston feed pump assembly, through a hopper. The hopper can include a vacuum assembly to draw air entrained between tenders from hopper, compressing the tenders to form a denser volume. Whole tenders are pumped to a pump assembly discharge to discharge whole pieces of tenders to a portioner. A piston pump can be used to reduce stresses that may be imparted to whole tenders during pumping. The low pressure delivery of tenders to the portioner helps to maintain the structural integrity of each tender or whole muscle piece.

A typical portioner includes a rotating drum having a plurality of recessed mold cavities dispersed along an outer periphery and are sold by several suppliers including, for example, Stork Food Systems USA (Gainesville, Ga., USA), and Formax, Inc. (Mokena, Ill., USA).

Mold cavities are in a three-dimensional shape desired to be the final shape of a portioned product. In an exemplary embodiment, mold cavities are sized such that portioned tenders weighing about at least 28 grams (about 1 oz) are portioned from whole tenders. Mold cavities are also shaped to portion the tenders to a desired and generally uniform thickness throughout the portioned tender. As an example, the maximum thickness can be controlled to be from about 9 to about 13 mm (about 0.4 to about 0.5 inches). Each mold cavity can include one or more air ports that use compressed air to provide an air blast to portioned tenders in order to eject portioned tenders from their respective mold cavities. Alternatively, a piston like mechanism can push the portioned tenders out of the mold. The portioned tenders can be directly placed on a conveyor 104 for coating. Coated tenders prepared according to the exemplary method of the present invention just described can weigh about 57 grams±7 grams (2 oz±0.3 oz). After a coating is applied in accordance with the present invention, coated tenders may be transported to a downstream location, such as a fryer, for further processing. A uniform thickness of about 9 mm to about 13 mm allows for a generally uniform cooking of coated tenders. After par-frying to set the coating, as is generally known in the art of preparing such coated products, tenders having a maximum thickness before breading of about 9 to about 13 mm, such as about 11 mm, can be fully cooked from a frozen state in oil. With such a thickness, coated tenders may be fully cooked in about four (4) minutes or less. With other dimensions, such as tenders having a larger thickness, coated tenders may be cooked in a longer time, such as about six (6) minutes.

In addition to being useful for whole muscle and portioned products, the present invention can also be used on formed products. Formed products are generally those products where a food product is chopped or ground and then formed into an individual piece. As with portioned products, it is difficult to prepare a formed product having a homestyle appearance using prior art coating methods due to stresses that create a tendency for the food product to be broken apart.

### EXAMPLES

Portioned tenders coated according to an embodiment of the present invention were compared to sized whole muscle tenders in separate sensory tests on four separate occasions. Samples designated “Control” are sized whole muscle tender breaded using a barrel breading system. Samples designated “Test” are portioned products prepared from tenders and coated using a batter-crumb-batter-bread process. The crumb is an extruded crumb having a mean particle size of between about 2 mm and about 4 mm and where about 68% of the crumbs have a particle size of about 4.75 mm or above and about 90% of the crumbs have a particle size of about 2.4 mm or above. The bread is a flour based mixture with flavor and seasoning additives. The number of panelists rating the product on each day is indicated. Results with the letter “a” appended are statistically the same. Statistically different results are labeled “b”.

Oct. 29, 2007 - Number of Panelists: 62

| | | Control | Test |
|---|---|---|---|
| Attribute Title | p value | Mean | Mean |
| Overall Appearance | 0.3350 | 7.13 a | 6.81 a |
| Overall Texture | 0.6430 | 7.16 a | 7.05 a |
| Overall Liking of Product | 0.1377 | 7.24 a | 6.98 a |

Jul. 27, 2007 - Number of Panelists: 61

| | | Control | Test |
|---|---|---|---|
| Attribute Title | p value | Mean | Mean |
| Appearance of the Product | 0.6511 | 7.52 a | 7.48 a |
| Overall Texture | 0.0052 | 6.98 b | 7.48 a |
| Overall Liking of Product | 0.0000 | 6.70 b | 7.48 a |

May 5, 2007 - Number of Panelists: 55

| | | Control | Test |
|---|---|---|---|
| Attribute Title | p value | Mean | Mean |
| Overall Appearance | 0.7075 | 7.18 a | 7.09 a |
| Overall Texture | 0.7369 | 7.16 a | 7.09 a |
| Overall Liking of Product | 0.2521 | 7.13 a | 6.82 a |

Apr. 12, 2007 - Number of Panelists: 64

| | | Control | Test |
|---|---|---|---|
| Attribute Title | p value | Mean | Mean |
| Overall Appearance | 0.3268 | 6.81 a | 6.61 a |
| Overall Texture | 0.4364 | 7.16 a | 7.00 a |
| Overall Liking of Product | 0.8866 | 6.88 a | 6.84 a |

As shown in the foregoing examples, use of the present method in a portioned product generally resulted in an appearance and texture that was statistically identical to that of a whole muscle coated according to prior art methods.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. A method of coating a food product comprising the steps of:
transporting the food product on a conveyor;
applying a first coating to the top and bottom surfaces of the food product while the food product is on the conveyor; and
subsequently applying a second coating while the food product is on the conveyor to produce a finished food product;
wherein the first coating is more coarse than the second coating.

2. The method of claim 1, wherein the first coating comprises a plurality of first crumbs having a mean particle size of between about 2 mm and about 4 mm, the first crumbs providing a rough texture on the food product.

3. The method according to claim 2, wherein about 68% of said first crumbs have a particle size of about 4.75 mm or above.

4. The method according to claim 2, wherein about 90% of said first crumbs have a particle size of about 2.4 mm or above.

5. The method according to claim 2, wherein the step of applying a first coating comprises the steps of:
applying a first batter; and
applying the plurality of first crumbs.

6. The method according to claim 1, wherein the second coating comprises a second crumb, the second crumb comprising a flour based coating.

7. The method according to claim 6 wherein the step of applying the second coating comprises the steps of
applying a second batter; and
applying the second crumb.

8. The method according to claim 1, further comprising, prior to the step of applying the first coating, the step of pre-dusting the food product.

9. A coated food product manufactured by a method comprising the steps of:
transporting the food product on a conveyor;
applying a first coating to top and bottom surfaces of the food product while the food product is on the conveyor; and
subsequently applying a second coating to top and bottom surfaces of the food product while the food product is on the conveyor;
wherein the first coating is more coarse than the second coating.

10. The coated food product according to claim 9, wherein the manufacturing method further comprises, prior to the first batter applying step, the step of pre-dusting the food product.

11. The coated food product according to claim 9, wherein the first coating comprises a plurality of crumbs having a mean particle size of between about 2 mm and about 4 mm that provide a rough texture on the food product.

12. The coated food product according to claim 9, wherein the second coating comprises a flour based seasoning and flavor mixture.

13. The coated food product according to claim 9, comprising a single portioned food product prepared from a plurality of whole muscle pieces or portions thereof, or a single whole muscle piece.

14. A coated food product comprising
a food product; and
a coating comprising separately applied first and second coatings; wherein
the first coating comprises a plurality of crumbs having a mean particle size of between about 2 mm and about 4 mm, and
the second coating is less coarse than the first coating, and
wherein the surface of the coated food product has rough texture.

15. The coated food product according to claim 14, wherein the plurality of crumbs have a mean particle size of between about 2 mm and about 4 mm.

16. The coated food product according to claim 15, wherein about 68% of the crumbs have a particle size of about 4.75 mm or above.

17. The coated food product according to claim 15, wherein about 90% of said crumbs have a particle size of about 2.4 mm or above.

18. The coated food product according to claim 14, wherein the food product is a single portioned food product from a plurality of whole muscle pieces.

19. The coated food product of claim 14, wherein the food product is a poultry product.

20. A system for coating a food product comprising:
a conveyor for transporting the food product;
means for applying a first coating to the exterior of the food product while the food product is on the conveyor; and
means for applying a second coating that is more coarse than the first coating to the food product while the food product is on the conveyor.

21. The system according to claim 20, wherein
means for applying a first coating comprises
means for applying a first batter to the exterior of the food product while the food product is on the conveyor; and
means for coating a first crumb to the exterior of the food product while the food product is on the conveyor; and
means for applying a second coating comprises
means for applying a second batter to the exterior of the food product while the food product is on the conveyor; and
means for applying a second crumb to the exterior of the food product while the food product is on the conveyor.
